(19) United States
(12) Patent Application Publication
(10) Pub. No.: US 2019/0011724 A1
(43) Pub. Date: Jan. 10, 2019

(54) GLASSES WITH REPLACEABLE LENSES

(71) Applicant: Lin Yun Chen, Tainan City (TW)

(72) Inventor: Lin Yun Chen, Tainan City (TW)

(21) Appl. No.: 15/644,776

(22) Filed: Jul. 8, 2017

(51) Int. Cl. G02C 5/22

(52) U.S. Cl. CPC G02C 5/22; G02C 2200/08

(57) ABSTRACT

Provided is a pair of glasses with replaceable lenses, including a frame having an upper end part, a lower end part and a first hinge part formed at both ends of the frame, and a lens groove is arranged therein; two legs respectively arranged on both sides of the frame, the front end of each leg includes a second hinge part and a limit slot; and two side covers arranged on both sides of the frame, each side cover include an upper buckle part, a lower buckle part, a limit part and a third hinge part. A pivot member pivots the first hinge part, the second hinge part and the third hinge part together. The upper buckle part and the lower buckle part respectively buckle the upper end part and the lower end part to fix a lens.

### BACKGROUND OF THE INVENTION

### 1. Field of the Invention

The present disclosure relates to a pair of glasses, and particularly relates to a pair of glasses with replaceable lenses.

### 2. The Prior Arts

In recent years, with the continuous improvement of material life, people are getting more and more attention to decorative items. Glasses wear has become one of the decorative items. In order to be able to match the clothing and consider the beauty, a variety of styles of glasses also came into being, and gradually popular. However, transparent lenses or colored lenses are inconvenient in replacement. It causes users to spend longer time to replace the lenses or needs to replace a whole pair of glasses; therefore, such replacement does not meet the economic interests.

Known glasses assembly must be completed by tools or bolts, resulting in the problem of difficult replacing the lenses. If the lenses cannot be firmly fixed on the frame, the lenses will be easy to fall off, and resulting in the user's inconvenience.

Accordingly, how to provide a structure that the users can quickly replace lenses without using any tools and can effectively fix the lenses on the frame is one of the important issues.

### SUMMARY OF THE INVENTION

It is a primary object of the present invention to provide a pair of glasses with replaceable lenses.

In order to achieve the above objective, the present disclosure provides a pair of glasses with replaceable lenses, including a frame having an upper end part, a lower end part and a first hinge part formed at both ends of the frame, wherein a lens groove is arranged inside the frame; two legs respectively arranged on both sides of the frame, wherein the front end of each of the two legs includes a second hinge part and a limit slot; and two side covers arranged on both sides of the frame, wherein each of the two side covers include an upper buckle part, a lower buckle part and a third hinge part, wherein a pivot member pivots the first hinge part, the second hinge part and the third hinge part together, the upper buckle part and the lower buckle part respectively buckle the upper end part and the lower end part to hold a lens; in the replacement of the lens, after each of the two legs is folded and each of the two side covers is pivoted outwardly, the upper end part and the lower end part are respectively disengaged from the upper buckle part and the lower buckle part so as to enable the lens to be removed from the lens groove.

Preferably, the first hinge part, the second hinge part and the third hinge part each have at least one through hole, the pivot member passes through the at least one through hole of the first hinge part, the second hinge part and the third hinge part, the first hinge part, the second hinge part and the third hinge part are pivoted together to produce a pivot, and each of the two side covers and each of the two legs are pivoted relative to the frame.

Preferably, the first hinge part and the second hinge part each have at least one through hole, the pivot member passes the at least one through hole, the first hinge part and the second hinge part are pivotally connected; the third hinge part of each of the two side covers has at least one protrusion and is opposite to the at least one protrusion of the third hinge part of each of the two side covers, the first hinge part of the frame includes at least one groove for receiving the at least one protrusion of the third hinge part of each of the two side covers in the at least one groove of the first hinge part of the frame to produce a pivot so that each of the two side covers is pivoted relative to the frame.

Preferably, when the two legs are not folded, the limit part of each of the two side covers is provided in the limit groove of the two legs.

Preferably, a belt is attached to the ends of the two legs.

Preferably, each of the two side covers includes a contacting surface against the upper and lower edges of the lens to hold the lens.

### BRIEF DESCRIPTION OF THE DRAWINGS

FIG. 1 shows a three-dimensional decomposition diagram of a pair of glasses with replaceable lenses according to a preferred embodiment of the present disclosure.

FIG. 2 shows a three-dimensional decomposition diagram of the main components of the glasses with replaceable lenses according to a preferred embodiment of the present disclosure.

FIG. 3 shows a three-dimensional diagram of the glasses with replaceable lenses according to a preferred embodiment of the present disclosure.

FIG. 4 shows a side view of the glasses with replaceable lenses taken along lines A-A of FIG. 3 according to a preferred embodiment of the present disclosure.

FIG. 5 shows an enlarged side view of the upper buckle part buckling the upper end part at position B of FIG. 4 according to a preferred embodiment of the present disclosure.

FIG. 6 shows an enlarged side view of the lower buckle part buckling the lower end part at position C of FIG. 4 according to a preferred embodiment of the present disclosure.

FIG. 7 shows a top view of the glasses with replaceable lenses according to a preferred embodiment of the present disclosure.

FIG. 8 shows a three-dimensional diagram of the limit slot of the legs of the glasses with replaceable lenses according to a preferred embodiment of the present disclosure.

FIG. 9 shows a side view of the pivot of the glasses with replaceable lenses according to a preferred embodiment of the present disclosure.

FIG. 10 shows a side view of the pivot, the protrusion and the groove of the glasses with replaceable lenses according to a preferred embodiment of the present disclosure.

FIG. 11 shows a three-dimensional diagram of a belt attached to the ends of the two legs of the glasses with replaceable lenses according to another preferred embodiment of the present disclosure.

### DETAILED DESCRIPTION OF THE PREFERRED EMBODIMENT

The detailed description of the present invention is provided in combination with the accompanying drawings.

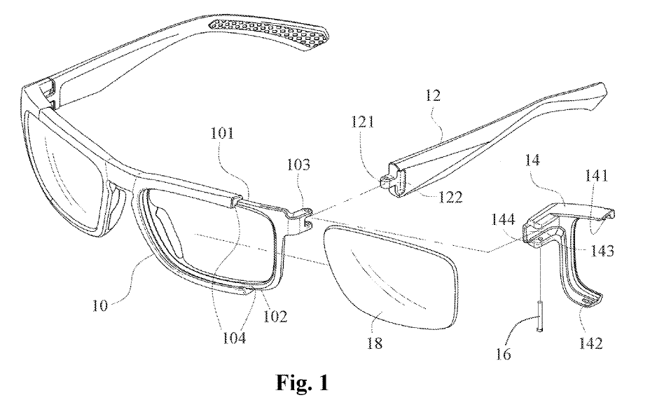

According to a preferred embodiment of the present disclosure, as shown in FIG. 1, a pair of glasses of the present disclosure includes a frame 10, two legs 12 and tow side covers 14.

As shown in FIG. 1, an upper end part 101, lower end part 102 and a first hinge part 103 are formed at both ends of the frame 10 of the present disclosure. A lens groove is arranged inside the frame.

According to a preferred embodiment of the present disclosure, as shown in FIG. 1, the two legs 12 of the present disclosure are respectively arranged on both sides of the frame 10. It should be noted that the frond end of each leg 12 includes a second hinge part 121 and a limit slot 122.

According to a preferred embodiment of the present disclosure, referring to FIG. 1, the two side covers 14 are respectively arranged on both sides of the frame 10. Each side cover includes an upper buckle part 141, a lower buckle part 142, a limit part 143 and a third hinge part 144.

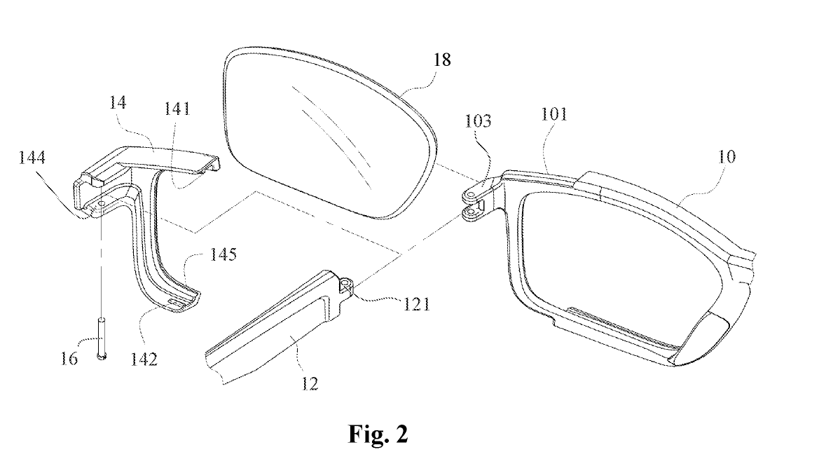

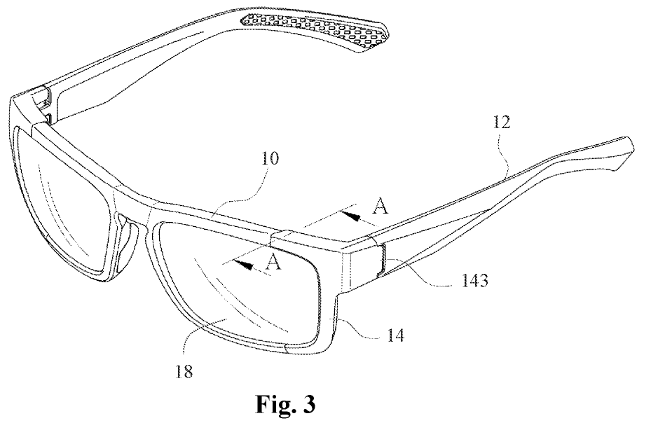

According to a preferred embodiment of the present disclosure, as shown in FIGS. 1 and 2, a pivot member 16 pivots the first hinge part 103 of the frame 10, the second hinge part 121 of each leg 12 and the third hinge part 144 of each side cover 14 together. The upper buckle part 141 and the lower buckle part 142 of each side cover buckle the upper end part 101 and the lower end part 102 of the frame 10 so as to hold a lens 18. FIG. 3 shows a three-dimensional diagram of the glasses with replaceable lenses of the present disclosure.

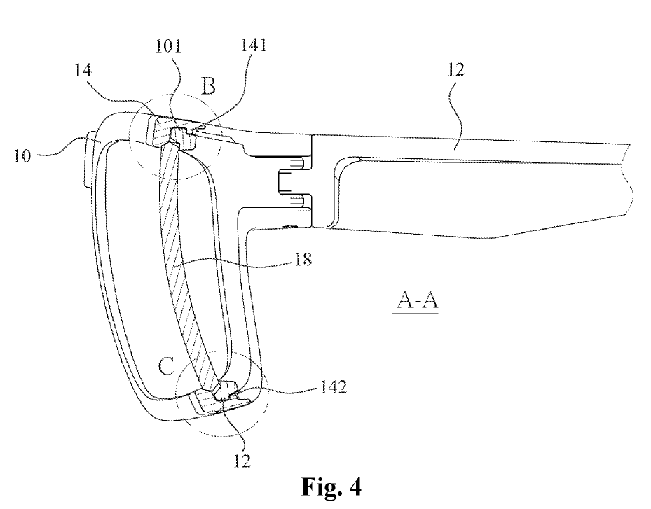

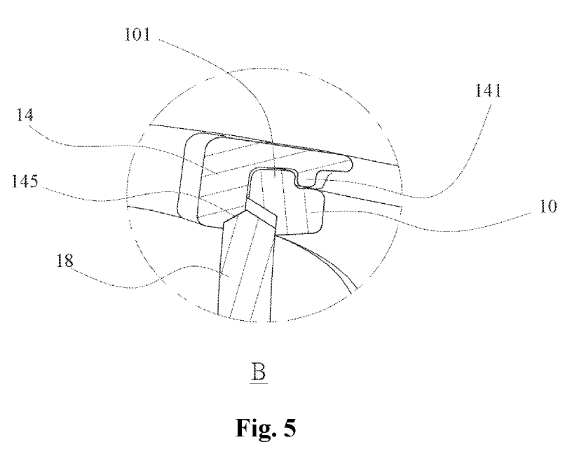

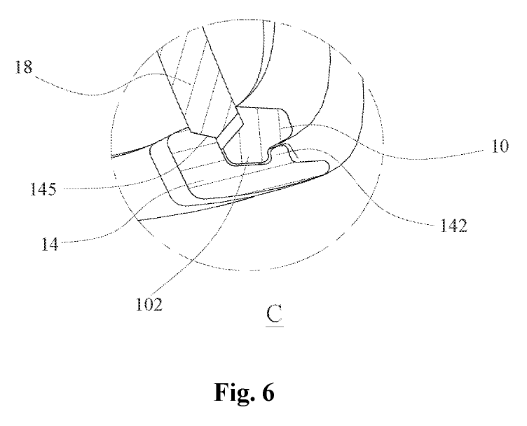

According to a preferred embodiment of the present disclosure, FIG. 4 shows a side view of the glasses with replaceable lenses taken along lines A-A of FIG. 3. FIG. 5 shows an enlarged side view of the upper buckle part 141 buckling the upper end part 101 at position B of FIG. 4. FIG. 6 shows an enlarged side view of the lower buckle part 142 buckling the lower end part 102 at position C of FIG. 4. It can be seen from FIG. 1 to FIG. 6, a pivot member 16 is used to pivot the third hinge part 144 of each side cover 14, the second hinge part 121 of each leg 12 and the first hinge part 103 of the frame 10 so as to hold a lens 18. The side cover 14 of the present disclosure also include a contacting surface 145 against the upper and lower edges of the lens 18 so as to effectively hold the lens 18.

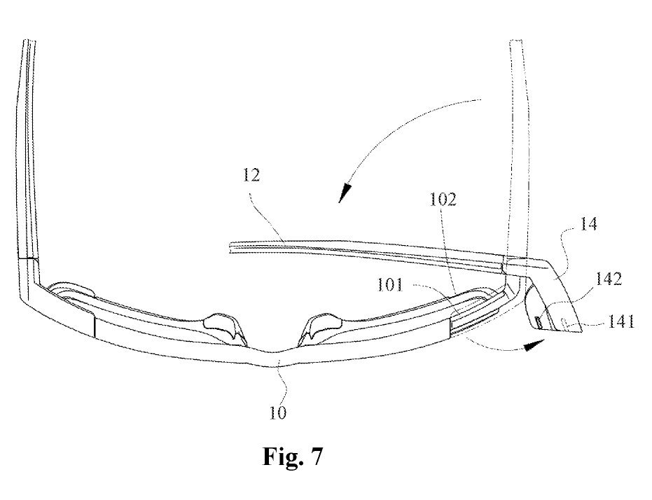

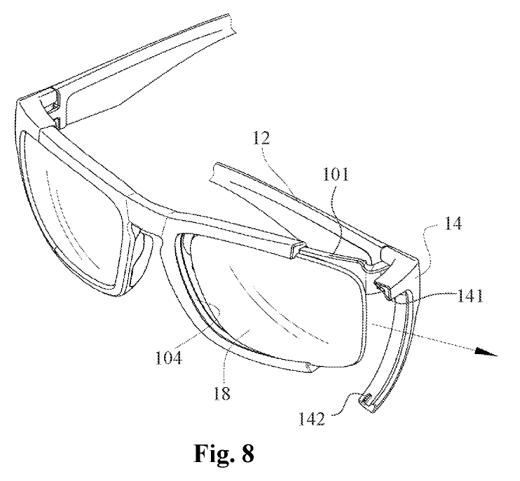

FIG. 7 shows a top view of the glasses with replaceable lenses of the present disclosure and FIG. 8 shows a three-dimensional diagram of the limit slot 122 of the legs 12 of the glasses with replaceable lenses of the present disclosure. Specifically, as shown in FIGS. 1, 7 and 8, when the lens 18 is replaced, each leg 12 can be folded, and each side cover 14 is biased outward such that the upper buckle part 141 and the lower buckle part 142 of each side cover 14 are respectively separated from the upper end part 101 and the lower end part 102 of the frame 10. The lens 18 can be pulled away from the lens groove 104, and the lens 18 is removed. It is worth noting that when each leg 12 is not folded, the limit part 143 of each side cover 14 is provided in the limit slot 122 of each leg 12. Since there is a limit slot 122 for each leg 12, each side cover 14 cannot be opened. Based on the above detailed description, the present disclosure can replace the lens 18 quickly without using any tools.

In addition, the present disclosure can replace the lens 18 quickly without using any tools. The color of the frame can be effectively replaced so as to enable the glasses to have two-color or multi-level effects.

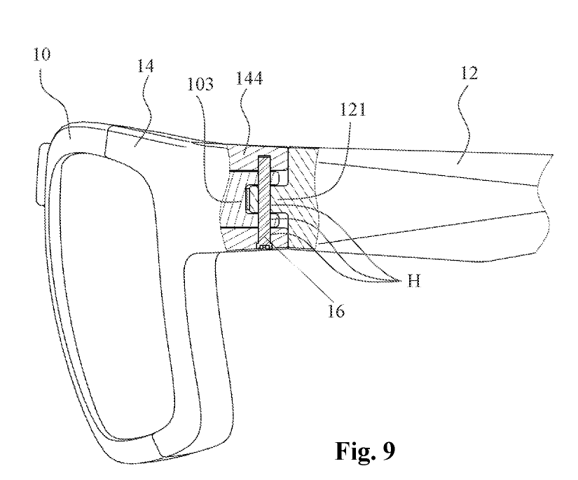

FIG. 9 shows a side view of the pivot of the glasses with replaceable lenses according to a preferred embodiment of the present disclosure. Referring to FIGS. 1 and 9, a pivot member 16 pivots the third hinge part 144 of each side cover 14, the second hinge part 121 of each leg 12 and the first hinge part 103 of the frame 10. Specifically, the first hinge part 103, the second hinge part 121 and the third hinge part 144 each have at least one through hole H. The pivot member 16 passes through the at least one through hole H of the first hinge part 103, the second hinge part 121 and the third hinge part 144. Accordingly, the first hinge part 103, the second hinge part 121 and the third hinge part 144 are pivoted together to produce a pivot, and each side cover 14 and each leg 12 are pivoted relative to the frame 10.

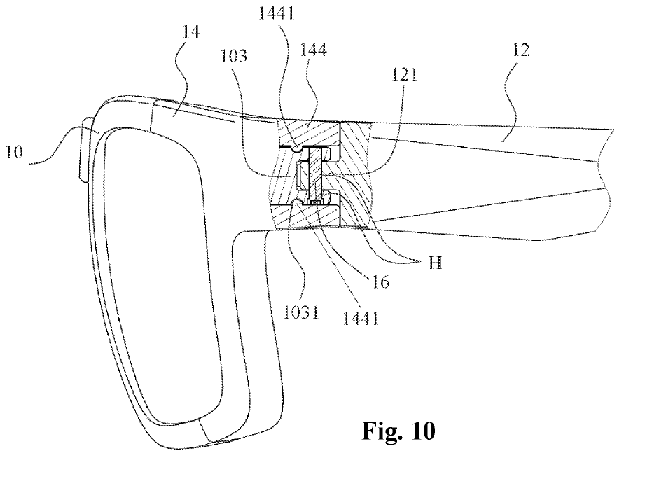

Moreover, according to another preferred embodiment of the present disclosure, as shown in FIG. 10, the first hinge part 103 and the second hinge part 121 each have at least one through hole H, the pivot member 16 passes at least one through hole H so as to pivotally connect the first hinge part 103 and the second hinge part 121. The third hinge 144 of each side cover 14 has at least one protrusion 1441 and is opposite to at least one protrusion 1441 of the third hinge part 144 of each side cover 14. The first hinge part 103 of the frame 10 includes at least one groove 1031 for receiving at least one protrusion 144 of the third hinge part 144 of each side cover 14 in at least one groove 1031 of the first hinge part 103 of the frame 10 to produce a pivot so that each side cover 14 is pivoted relative to the frame 10. As shown in FIG. 10, the protrusion 1441 is in the form of a sphere, and the groove 1031 is in the form of a groove, but it is not intended to limit the appearance of the protrusion 1441 and the groove 1031. The formation of convex and concave corresponding to the structure and feasible pivotal movement belongs to the scope of the present disclosure. Further, since the side covers 14 of the present disclosure do not need to be pivoted via the pivot member 16, the user can directly urge the protrusion 14 of each side cover 14 away from the groove 1031 of the frame 10 so as to replace each side cover 14 with different colors.

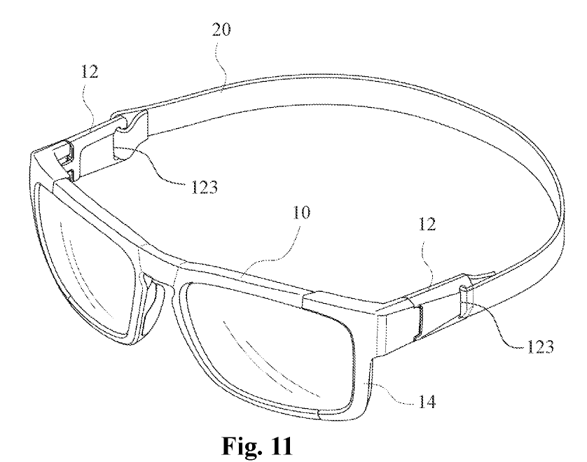

FIG. 11 shows a three-dimensional diagram of a belt 20 attached to the ends of the two legs 12 of the glasses with replaceable lenses according to another preferred embodiment of the present disclosure. The end of each leg 12 is provided with an aperture 123. Both ends of the belt 20 are respectively fixed to the apertures 123 of the legs 12 so as to suitable for the users with different needs.

To sum up, as shown in FIG. 1 to FIG. 11, a pair of glasses with replaceable lenses of the present disclosure has the following advantages. Since the lenses are held by the frame, two legs and two side covers. Accordingly, the glasses of the present disclosure allow users to quickly replace the lenses without using any tools such that the time required to replace the lenses can be effectively shortened. Moreover, the color of the frame can also be effectively replaced so as to enable the glasses to have tow-color or multi-level effects.

Although the present disclosure has been described with reference to the preferred exemplary preferred embodiments thereof, it is apparent to those skilled in the art that a variety of modifications and changes may be made without departing from the scope of the present disclosure which is intended to be defined by the appended claims.

What is claimed is:

1. A pair of glasses with replaceable lenses, comprising:
a frame having an upper end part, a lower end part and a first hinge part formed at both ends of the frame, wherein a lens groove is arranged inside the frame;
two legs respectively arranged on both sides of the frame, wherein the front end of each of the two legs includes a second hinge part and a limit slot; and
two side covers respectively arranged on both sides of the frame, wherein each of the two side covers includes an upper buckle part, a lower buckle part and a third hinge part,
wherein a pivot member pivots the first hinge part, the second hinge part and the third hinge part together, the upper buckle part and the lower buckle part respectively buckle the upper end part and the lower end part to hold a lens; in the replacement of the lens, after each of the two legs is folded and each of the two side covers is pivoted outwardly, the upper end part and the lower end part are respectively disengaged from the upper buckle part and the lower buckle part so as to enable the lens to be removed from the lens groove.

2. The pair of glasses with replaceable lenses of claim 1, wherein the first hinge part, the second hinge part and the third hinge part each have at least one through hole, the pivot member passes through the at least one through hole of the first hinge part, the second hinge part and the third hinge part, the first hinge part, the second hinge part and the third hinge part are pivoted together to produce a pivot, and each of the two side covers and each of the two legs are pivoted relative to the frame.

3. The pair of glasses with replaceable lenses of claim 1, wherein the first hinge part and the second hinge part each have at least one through hole, the pivot member passes the at least one through hole so as to pivotally connect the first hinge part with the second hinge part; the third hinge part of each of the two side covers has at least one protrusion and is opposite to the at least one protrusion of the third hinge part of each of the two side covers, the first hinge part of the frame includes at least one groove for receiving the at least one protrusion of the third hinge part of each of the two side covers in the at least one groove of the first hinge part of the frame to produce a pivot so that each of the two side covers is pivoted relative to the frame.

4. The pair of glasses with replaceable lenses of claim 1, wherein when the two legs are not folded, the limit part of each of the two side covers is provided in the limit groove of the two legs.

5. The pair of glasses with replaceable lenses of claim 1, wherein a belt is attached to the ends of the two legs.

6. The pair of glasses with replaceable lenses of claim 1, wherein each of the two side covers includes a contacting surface against the upper and lower edges of the lens to hold the lens.
